(19) United States
(12) Patent Application Publication
(10) Pub. No.: US 2010/0265260 A1
(43) Pub. Date: Oct. 21, 2010

(54) Automatic Management Of Buffer Switching Using A Double-Buffer

(76) Inventors: Jerzy Wieslaw Swic, Vancouver (CA); George Lyons, Langley (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 12/425,540

(22) Filed: Apr. 17, 2009

(51) Int. Cl. G09G 5/399

(52) U.S. Cl. 345/539

(57) ABSTRACT

An apparatus for double-buffering a sequence of frames of pixel data for display is disclosed. The apparatus comprises two frame buffers, a read unit to read a first frame of pixel data from a first one of the two frame buffers, a write-switch point determiner, and a write-buffer selector. The write-switch point determiner determines a safe write-switch point in the first one of the two frame buffers. The safe write-switch point is determined, at least in part, by an average rate at which data is written to the frame buffers and an average rate at which data is read from the frame buffers. The write-buffer selector determines if the reading of the first frame has progressed beyond the safe write-switch point, and selects one of the two frame buffers to write a second frame of pixel data based on the determination.

### FIELD

The subject matter described relates generally to buffering a sequence of frames of pixel data using a double-buffer.

### BACKGROUND

A video image is formed from a sequence of frames displayed in rapid succession. A video source, such as a camera, may capture individual frames for storage in a memory. The frames are read out from the memory and transmitted to a display device for display. An artifact known as “image tearing” can occur when a new frame is written to the memory at the same time that a previously stored frame is being read out for display. If the writing of the new frame overtakes the reading of the previous frame, the displayed image will be a composite of the new and previous frames, and objects that appear in different locations in the two frames will be inaccurately rendered.

To prevent image tearing, a double-buffer technique may be used. Two buffers are provided. While a previously stored first frame is read out of a first buffer, a second frame is written to a second buffer. When the reading and writing operations finish, the roles of the first and second buffers are switched, i.e., the second frame is read out of the second buffer while a third frame is written to the first buffer. Double-buffering prevents image tearing because simultaneous reading and writing operations in the same buffer are prohibited. If the rates at which frames are written to and read from the two buffers are not equal, the double-buffer technique results in a problem of frame dropping. Frame dropping problem can be quite objectionable to viewers.

Another problem with the double-buffer technique is that the rates at which frames are written to and read from the two buffers must be known in advance. In addition, double-buffering techniques generally assume that the rates at which frames are written to and read from the two buffers do not vary with time.

Accordingly, there is a need for methods and apparatus for double-buffering image data in a manner which reduces the number of dropped frames.

### SUMMARY

One embodiment is directed to an apparatus for double-buffering a sequence of frames of pixel data for display. The apparatus comprises two frame buffers, a read unit to read a first frame of pixel data from a first one of the two frame buffers, a write-switch point determiner, and a write-buffer selector. The write-switch point determiner determines a safe write-switch point in the first one of the two frame buffers. The safe write-switch point is determined, at least in part, by an average rate at which data is written to the frame buffers and an average rate at which data is read from the frame buffers. The write-buffer selector determines if the reading of the first frame has progressed beyond the safe write-switch point, and selects one of the two frame buffers to write a second frame of pixel data based on the determination.

One embodiment is directed to a method for buffering a sequence of frames of pixel data. The method includes reading pixel data of a first frame from a first one of two frame buffers, and writing pixel data of a second frame to a second one of the two frame buffers. The method also includes determining a rate difference ratio based on a ratio of an input rate and an output rate. The input rate is a rate at which pixel data is written to the two frame buffers and the output rate is a rate at which pixel data is read from the two frame buffers. In addition, the method includes determining a safe write-switch point in the first frame buffer based at least in part on the rate difference ratio. Further, the method includes determining whether the reading of pixel data from the first frame buffer has progressed beyond the safe write-switch point. Additionally, the method includes selecting one of the two frame buffers to write the pixel data of a third frame to based on the determination of whether the reading of pixel data from the first frame buffer has progressed beyond the safe write-switch point. The first buffer is not selected to receive pixel data of the third frame if the reading of the first frame has not progressed beyond the safe write-switch point.

One embodiment is directed to an apparatus for double-buffering a sequence of frames of pixel data for display. The apparatus comprises two frame buffers, and a read unit to read a first frame of pixel data from a first one of the two frame buffers for display, a write-switch point determiner, and a write-buffer selector. The write-switch point determiner determines a safe write-switch point in the first one of the two frame buffers. The safe write-switch point is determined, at least in part, by an average rate at which data is written to the frame buffers and an average rate at which data is read from the frame buffers. The write-buffer selector determines if the reading of the first frame has progressed beyond the safe write-switch point, and selects one of the two frame buffers to write a second frame of pixel data based on the determination. The write-buffer selector selects a second one of the two frame buffers to write the second frame based on a determination that the reading of the first frame has not progressed beyond the safe write-switch point. In addition, at least one of a rate at which data is written to the frame buffers and a rate at which data is read from the frame buffers is a non-constant rate.

This summary is provided to generally describe what follows in the drawings and detailed description and is not intended to limit the scope of the invention. Objects, features, and advantages of the invention will be readily understood upon consideration of the following detailed description taken in conjunction with the accompanying drawings.

### BRIEF DESCRIPTION OF THE DRAWINGS

FIG. 1 is a block diagram of a display system having a display controller.

FIG. 2 illustrates two frame buffers included in the display controller of FIG. 1.

FIG. 3 is a block diagram of a buffer selection unit included in the display controller of FIG. 1.

FIG. 4 illustrates representative timing characteristics associated with the reading or writing of a frame.

FIGS. 5 and 6 illustrates two frame buffers included in the display controller of FIG. 1 and a safe write-switch address.

FIG. 7 is a flow diagram of a method for selecting one of two frame buffers.

### DETAILED DESCRIPTION

In the following detailed description of exemplary embodiments, reference is made to the accompanying drawings, which form a part hereof. In the several figures, like referenced numerals identify like elements. The detailed description and the drawings illustrate exemplary embodiments. Other embodiments may be utilized, and other changes may be made, without departing from the spirit or scope of the subject matter presented here. The following detailed description is therefore not to be taken in a limiting sense, and the scope of the claimed subject matter is defined by the appended claims.

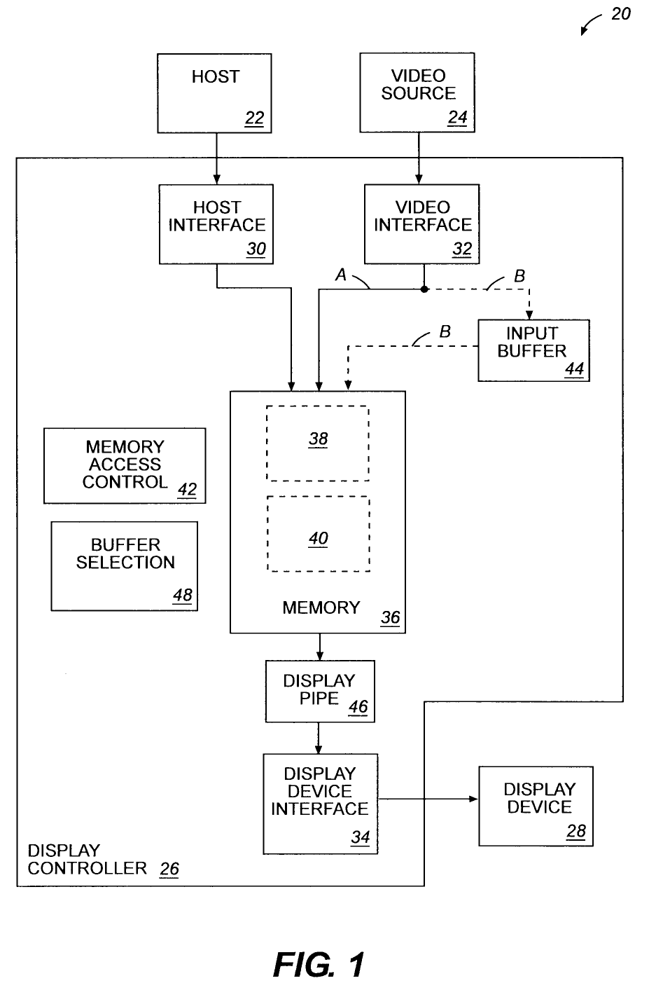

FIG. 1 illustrates one of multiple contexts in which embodiments may be implemented. FIG. 1 is a block diagram illustrating a display system 20. The display system 20 may be provided in a device where minimizing power consumption is important, such as a battery-powered device. However, it is not critical that minimizing power consumption be important in a device embodying the system 20. Some examples of devices in which the system 20 may be employed include mobile telephones, personal digital assistants, digital cameras, and portable media players.

The display system 20 may include a host 22, a video source 24, a display controller 26, and a display device 28. The display controller 26 may include the blocks shown in FIG. 1 and described in more detail below, as well as other units that are not shown in the figure in order not to obscure this description.

The host 22 may be a general purpose microprocessor, digital signal processor, controller, computer, or any other type of device, circuit, or logic that executes instructions (of any computer-readable type) to perform operations.

The video source 24 may be a camera, a CCD sensor, a CMOS sensor, a memory for storing frames of image data, a receiver for receiving frames of image data, a transmitter for transmitting frames of image data, or any other suitable video source. The video source 24 may output data in a variety of formats or in conformance with a variety of formats or standards. Some example formats and standards include the S-Video, SCART, SDTV RGB, HDTV RGB, SDTV YPbPr, HDTV YPbPr, VGA, SDTV, HDTV, NTSC, PAL, SDTI, HD-SDTI, VMI, BT.656, ZV Port, VIP, DVI, DFP, OpenLDI, GVIF, and IEEE 1394 digital video interface standards. While FIG. 1 shows a single video source 24, in alternative configurations the display system 20 may include two or more video sources.

The display device 28 may be an LCD, CRT, plasma, OLED, electrophoretic, or any other suitable display device. While FIG. 1 shows a single display device 28, in alternative configurations the display system 20 may include two or more display devices.

The display controller 26 interfaces the host 22 and the video source 24 with the display device 28. The display controller 26 may output video data to the display device in a variety of formats or in conformance with a variety of formats or standards, such as any of those listed above as exemplary interface formats and standards for output from the video source 24, i.e., S-Video, SCART, etc. The display controller 26 may be separate (or remote) from the host 22, video source 24, and the display device 28. The display controller 26 may be an integrated circuit.

The display controller 26 includes a host interface 30, a video interface 32, and a display device interface 34. The host interface 30 provides an interface between the host 22 and the display controller 26. The video interface 32 provides an interface between one or more video sources and the display controller 26. In alternative configurations, the host and video interfaces may be combined in a single interface. The display device interface 34 provides an interface between the display controller 26 and one or more display devices.

An image rendered on a display device is comprised of many small picture elements or “display pixels.” The one or more bits of data defining the appearance of a particular display pixel may be referred to as a “data pixel” or “pixel.” The image rendered on a display device is thus defined by pixels, which may be collectively referred to as a “frame.” Accordingly, it may be said that a particular image rendered on a display device is defined by a frame of pixel data. Commonly, the display pixels are arranged in rows (or lines) and columns forming a two-dimensional array of pixels. The characteristics of a pixel, e.g., color and luminance, are defined by one or more bits of data. A pixel may be any number of bits. Some examples of the number of bits that may be used to define a display pixel include 1, 8, 16, or 24 bits.

In one embodiment, a frame comprises all of the data needed to define all of the pixels in an image. In one embodiment, a frame includes only the data pixels that define an image. In one embodiment, there is a one-to-one correspondence between the display pixels of a display device and the data pixels included in a frame. In one embodiment, a frame does not include graphics primitives, such as lines, rectangles, polygons, circles, ellipses, or text in either two- or three-dimensions. In one embodiment, a frame comprises all of the data needed to define the display pixels of an image and the only further processing of the pixel data that is required before transmitting the pixels to the display device is to convert the pixels from a digital data value into an analog signal.

The display controller 26 may include a memory 36. In alternative embodiments, the memory 36 may be separate (or remote) from the display controller 26. The memory 36 may be an SRAM, VRAM, SGRAM, DDRDRAM, SDRAM, DRAM, flash, hard disk, or any other suitable memory. Data is stored in the memory 36 at a plurality of memory locations, each location having an address or other unique identifier. A memory address may identify a bit, byte, word, pixel datum, or any other desired unit of data. As described below, two frames may be stored in the memory 36. In this regard, particular memory addresses may identify the first line of a frame, first pixel in a line of a frame, or the first pixel in a group of pixels. In one embodiment, the memory 36 may be single-ported, i.e., that is only one address or memory location may be accessed at any one point in time. In one embodiment, the memory 36 may be multi-ported.

The memory 36 includes two frame buffers 38 and 40, each sized for storing one frame. As one of many possible examples, a frame may have dimensions of 720×576 pixels. In this example, each of the frame buffers 38 and 40 may be of a size sufficient to store 414,720 data pixels, each datum defining one pixel. In one embodiment, a frame comprises all of the data needed to define all of the pixels in an image may include control data, such as an end of file marker. Where control data is included, it is not stored in the frame buffers 38 and 40. It is not critical that the frame buffers 38 and 40 be contained in a single memory. In one alternative, two separate memories may be provided.

The pixels of an image may be arranged in a predetermined order. For example, the pixels of a frame may be arranged in raster order. A raster scan pattern begins with the left-most pixel on the top line of the array and proceeds pixel-by-pixel from left-to-right. After the last pixel on the top line, the raster scan pattern jumps to the left-most pixel on the second line of the array. The raster scan pattern continues in this manner scanning each successively lower line until it reaches the last pixel on the last line of the array. A frame may be stored at particular addresses in one of the frames buffers 38, 40 such that the pixels are arranged in raster order. However, this is not essential. Pixels may be arranged such that individual pixel components are grouped together in a frame buffer, each group of pixel components being arranged in a predetermined order, such as a raster-like order. In addition, a frame may be stored at particular addresses in one of the frames buffers 38, 40 so that the pixels are not be arranged in raster order if, for example, the frame had been compressed or coded prior to storing, in which case the compressed or coded data may be arranged in any suitable predetermined order.

A compression or coding algorithm may be applied to frames before they are stored or as part of the process of storing a frame in one of the frame buffers 38, 40. In these embodiments, a decompression or decoding algorithm may be applied to frames after they are read or as part of the process of reading a frame from a frame buffer. Any suitable compression or coding algorithm or technique may be employed. A compression or coding algorithm or technique may be “lossy” or “lossless.” For example, each line of pixels may be compressed using a run-length encoding technique. As another example, each line may be divided into groups of pixels and each of these groups may be individually compressed. For instance, each line may be divided into groups of 32 pixels, each group of 32 pixels being compressed before storing. Other examples of algorithms and techniques include the JPEG, MPEG, VP6, Sorenson, WMV, RealVideo compression methods.

As mentioned, the memory 36 includes two frame buffers 38 and 40, each sized for storing one frame. In one embodiment, the frame buffers 38 and 40 may be of a size sufficient to store all of the compressed or coded pixel data necessary to define all of the decompressed or decoded pixels of a frame. In one embodiment, particular images rendered on a display device are defined by frames of pixel data, wherein the pixel data includes data pixels that have been compressed or encoded.

Pixels may be defined in any one of a wide variety of different color models (a mathematical model for describing a gamut of colors). Color display devices generally require that pixels be defined by an RGB color model. However, other color models, such as a YUV-type model, can be more efficient than the RGB model for processing and storing pixel data. In the RGB model, each pixel is defined by a red, green, and blue component. In the YUV model, each pixel is defined by a brightness or luminance component (Y), and two color or chrominance components (U, V). In the YUV model, pixel data may be under-sampled by combining the chrominance values for neighboring pixels. For example, in a YUV 4:2:0 color sampling format, four pixels are grouped such that the original Y parameters for each of the four pixels in the group are retained, but a single set of U and V parameters is used as the U and V parameters for all four pixels. This contrasts with 4:4:4 sampling in which pixel data are treated as separate pixels, each pixel having its own Y, U, and V parameters. When YUV pixel data is provided in an under-sampled color sampling format (4:2:0, 4:1:1, etc.), individual pixel values are reconstructed from the group parameters before display.

As mentioned, the memory 36 includes two frame buffers 38 and 40, each sized for storing one frame. In one embodiment, the frame buffers 38 and 40 may be of a size sufficient to store all of the pixel data components obtained using an under-sampling technique and that are necessary to reconstruct all of the pixels of a frame, i.e., a frame buffer may be sized to store pixel data defining a frame wherein fewer than all of the color components necessary to define a particular pixel are stored for each pixel. For example, the frame buffers 38 and 40 may be of a size sufficient to store a frame's worth of under-sampled color sampling format 4:2:0 or 4:1:1 YUV-type pixel data. In one embodiment, particular images rendered on a display device are defined by frames of pixel data, wherein the pixel data includes pixel data components obtained using an under-sampling technique that are necessary to reconstruct all of the data pixels of a frame.

As mentioned, a frame may be stored at particular addresses in one of the frames buffers 38, 40 so that the pixels of the frame are arranged in raster order. In one embodiment, such as when the pixel data is compressed or coded on a block-by-block basis before storing, the compressed pixel data may be stored on a block-by-block basis. In addition, when groups of pixel data from the same line are compressed or coded basis before storing, the compressed pixel data may be stored on a pixel-group-by-pixel-group basis. In one embodiment, such as when the pixel data is defined in a YUV-type model, the pixel data may be stored in groups of color components, e.g., the Y pixel components may be stored together as a group and the U and V pixel components may be stored together as a group.

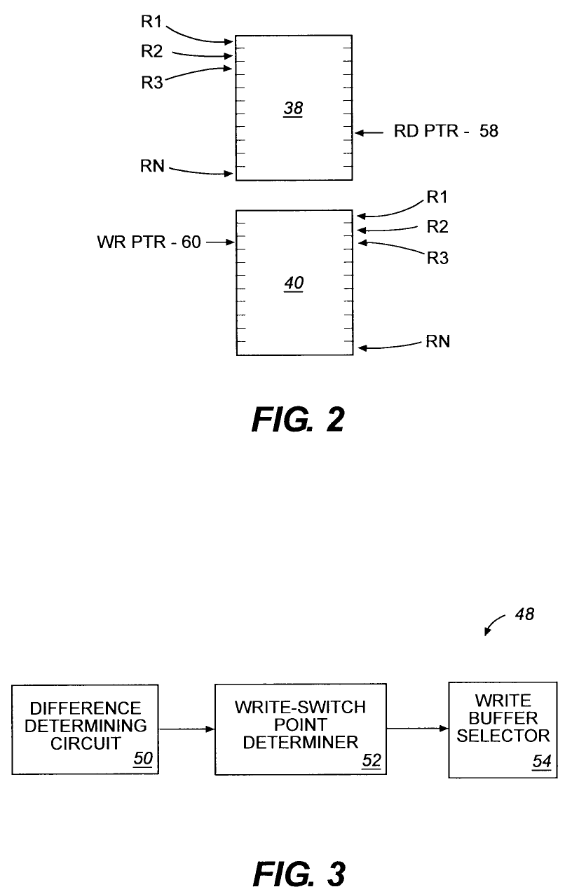

FIG. 2 is a simplified visual model of the two exemplary frame buffers 38 and 40 included in the display controller of FIG. 1. To simplify this description, it is assumed that FIG. 2 is sized to store a frame of pixel data that has not been compressed or that has had its color components under-sampled. Further, it is assumed that pixels are arranged in raster order in the memory, with one line of pixels of a frame stored in one of the rows R1, R2, R3, . . . RN of a frame buffer. The address of a frame buffer that was last accessed, that is currently begin accessed, or that will be accessed next may be monitored. For example, a read pointer 58 (“RD PTR”) may designated an address in a frame buffer that was last read, that is currently begin read, or that will be read next. Similarly, a write pointer 58 (“WR PTR”) may designated the address in a frame buffer that was last written to, that is currently begin written to, or that will be written to next. In FIG. 2, if a frame is written to or read from a buffer in raster order, the read pointer 58 and write pointer 60 move from top to bottom in the figure as pixel data is transferred because the pixels in this example are arranged in the buffers in raster order. If the input and output rates are close to the same rate, the read pointer 58 and the write pointer 60 will move at comparable speeds except for times when one of the pointers is stalled in a non-display period.

While the read pointer 58 and the write pointer 60 will move from top to bottom in the FIG. 2 when pixel data is arranged in the buffers in raster order, in alternative embodiments, such as where pixel data is not arranged in the buffers in raster order, the read pointer 58 and the write pointer 60 may not move from top to bottom. In these alternative embodiments, the read pointer 58 and the write pointer 60 may move according to a predetermined order corresponding with the arrangement of the data.

The two frame buffers 38 and 40 function as a double-buffered memory. As the video source 24 generates a sequence of frames for display, the frames are written into the double-buffered memory. The frames are then read from the double-buffered memory and displayed on the display device 28. An incoming frame may be written to a first one of the buffers while a previously stored frame is read from a second one of the buffers for display. When the reading and writing operations finish, the roles of the two buffers may be switched, i.e., the frame stored in the first buffer may be read out for display while a next incoming frame is written to the second buffer. Double-buffering prevents image tearing because simultaneous reading and writing operations in the same buffer are generally prohibited. If the rates at which frames are written to and read from the two buffers are not equal, however, the double-buffer technique may result in a problem of frame dropping, which can be quite objectionable to viewers.

One reason for the frame-dropping problem is that it is often not possible to temporarily pause the outputting of frames by the video source. For example, if the writing of a second frame to a second buffer finishes before a previously stored first frame can be completely read out of a first buffer, the prohibition on simultaneous reading and writing operations in the same buffer prevents the video source from writing a third frame to the first buffer. The video source, however, continues to send data. Because the first buffer is not immediately available, the third frame may either be stored in the second buffer or discarded. Of course, writing the third frame to the second buffer overwrites the second frame before it can be read out for display. Thus, either the second or third frame will be dropped.

In one embodiment, simultaneous reading and writing operations in the same buffer are not prohibited. Rather, simultaneous reading and writing operations in the same buffer are permitted when certain conditions are satisfied.

Frames of video data may be written to or read out from the frame buffers using either a progressive or an interlaced scanning technique. When progressive scanning is employed, the entire frame is scanned in raster order. As further explained below, a VSYNC signal may demark the temporal boundaries of a frame transfer period. When interlaced scanning is employed, each frame is divided into two fields, where one field contains all of the odd lines and the other contains all of the even lines, and each field is alternately scanned, line by line, from top to bottom. With interlaced scanning, two transfer periods, each demarked by a VSYNC signal, are necessary to transfer a full frame.

Referring again to FIG. 1, the display controller 26 may include a memory access control unit 42. The memory 36 may be accessed by the host interface 30, the video interface 32, the display interface 34, and other units (not shown in FIG. 1) of the display controller 26. As mentioned, the memory 36 may be single-ported. Two or more units may wish to access the memory 36 at the same time. The memory access control unit 42 arbitrates access to the single port of the memory 36, determining which requester may gain access to the memory 36 at any particular time.

The memory 36 may be accessed at a memory clock rate. Pixel data may be written to the memory 36 at an input rate. Pixel data may read from the memory 36 at an output rate. It should be understood that these input and output rates are rates at which data is transferred and that these rates may not refer to a clock rate, such as the memory clock rate. As one example, pixel data may be written to the memory 36 at an input rate of 30 frames per second or 12,441,600 pixels per second (assuming a frame size of 720×576), while the memory 36 may be clocked at a memory clock rate of 48 MHz.

The memory clock rate may be set high enough above expected data rates for accessing the memory 36 so that sufficient memory bandwidth is available to meet expected demands for memory access. On the other hand, while the memory clock rate may be set high enough to meet generally expected or average expected demand for access, it is desirable to not set the memory clock rate so high that every conceivable bandwidth demand may be met.

The display controller 26 may include an input buffer 44. The video interface 32 writes frames of image data directly to the memory 36 (via path “A”). In one embodiment, the video interface 32 may write a portion of a frame to the input buffer 44 (via path “B”) for subsequent transfer to the memory 36. Such “portions” may be, for example, a group of 24 pixels, a line of pixels, or two lines of pixels. In addition, such “portions” may be, for example, a group of 24 compressed pixels, a compressed line of pixels, or two compressed lines of pixels. It may not be possible to pause the writing of pixel data to the memory 26 without causing a loss of some of the pixel data. If the host 22 is granted permission to access the memory 36 at a time when pixel data from the video source is being written to the memory 36, pixel data that is transmitted during the host memory access time may be stored in the input buffer 44 in order to prevent data loss. When the host 22 finishes accessing the memory 36, the pixel data stored in the input buffer 44 may be written to the memory 36 and when this transfer is complete, the direct writing (via path “A”) of pixel data received from the video source 24 into the memory 36 may continue.

The display controller 26 may include one or more display pipes 46. Pixels fetched from the memory 36 may be stored in a display pipe 46 before being transmitted to the display device 28 via the display device interface 34. In one embodiment, display pipe 46 may include a read logic (not shown) to read pixel data from either one of the two frame buffers 38, 40. In one alternative embodiment, the display controller 26 may include a read unit (not shown) to read pixel data from either one of the two frame buffers 38, 40, and to provide the pixel data that it reads from a frame buffer to the one or more display pipes 46. In one embodiment, the display pipe 46 is a FIFO buffer. The display pipe 46 may receive pixels at an output rate. As stated above, the output rate is a data rate.

Either the input or output data rates may vary with time or be non-constant rates. With many video sources and display devices, data is provided by the video source at a constant data rate, and the display device requires that data be provided to it at a constant data rate. However, if incoming data is buffered in the input buffer 44 before storing because, for example, memory access has been granted to the host, the input data rate may vary with time or be a non-constant rate. In addition, if the storing of outgoing data in the display pipe 46 is paused for one or more periods of time because, for example, memory accesses have been granted to the host, the output data rate may vary with time or be a non-constant rate.

Referring again to FIG. 1, the display controller may 26 include a buffer selection unit 48. The buffer selection unit 48 serves to select one of the two frame buffers 38, 40. The buffer selection unit 48 may select a frame buffer using, in whole or in part, the subject matter described herein.

FIG. 3 is a block diagram illustrating buffer selection unit 48 in greater detail. The buffer selection unit 48 includes a difference determining circuit 50, a write-switch point determiner 52, and a write buffer selector 54.

The buffer selection unit 48 includes a difference determining circuit 50 that determines a difference between an input rate and an output rate. As mentioned, the input rate is a rate at which data is written to the frame buffers 38, 40, and the output rate is a rate at which data is read from the frame buffers 38, 40. The determination of the difference between the input rate and the output rate by the buffer selection unit 48 may include determining an average input rate and an average output rate. In addition, the difference between an input rate and an output rate may be expressed as a “rate difference” ratio or, in the case of average input rate and an average output rate, as an “average rate difference” ratio. For example, the difference between an input rate and an output rate may be expressed as one of the following rate difference ratios:

$$\begin{matrix}\frac{OutFR}{InFr} , or & ( 1 ) \\ \frac{InFr}{OutFr} & ( 2 )\end{matrix}$$

where “OutFr” is the output data rate and “InFr” is the input data rate, or where “OutFr” is an average output data rate and “InFr” is an average input data rate. The difference determining circuit 50 may determine either of the above ratios by keeping track of the relationship between one or more input start of frame pulses and one or more output start of frame pulses. One example of a start of frame pulse is a VSYNC pulse that is described below.

The input and output data rates or the average input and output data rates may be determined by the buffer selection unit 48 with respect to frames as a frame rate. However, this is not essential. In one embodiment, these rates may be determined with respect to line of pixels as a line rate. In one embodiment, these rates may be determined with respect to groups of pixels as a pixel-group rate. As one example, these rates may be determined with respect to groups of 24 pixels. While the difference determining circuit 50 may determine either of the above ratios (1) or (2) by keeping track of the relationship between an input start of frame pulses and an output start of frame pulses, this is not essential. Other signals may be used to keep track of the relationship between the input and output units of data being tracked. As one example, the difference determining circuit 50 may keep track of input and output start of line pulses, such as a HSYNC pulse that is described below. As another example, the difference determining circuit 50 may keep track of input and output groups of pixels using signals generated by one or more counters.

In one embodiment, the difference determining circuit 50 may include hardware logic that determines either of the above ratios by counting frame start pulses and performing division. A divider logic circuit, however, typically requires a relatively large number of gates. In one embodiment, the difference determining circuit 50 may include a hardware logic circuit that estimates either of the above ratios without requiring divider logic. In one embodiment, the difference determining circuit 50 may include an operability to execute instructions stored on a computer-readable medium to determine either of the above ratios.

As one example of an implementation of the difference determining circuit 50 that does not require a divider logic circuit, the difference determining circuit 50 may include a hardware up/down counter that is initialized to a mid-point count value, and then incremented each time an input start of frame pulse is detected and decremented each time an output start of frame pulse is detected. (Alternatively, the hardware up/down counter may be decremented each time an input start of frame pulse is detected and incremented each time an output start of frame pulse is detected.) In this example, the difference determining circuit 50 determines an average rate difference ratio. For example, the difference determining circuit 50 may include a 5-bit up/down counter (not shown), which counts up from 0 to 31. With a 5-bit hardware up/down counter, either 15d or 16d may be selected as a mid-point count value. In addition to the 5-bit hardware up/down counter, a 4-bit hardware up-counter (not shown) may be included in the difference determining circuit 50. (Alternatively, a 4-bit hardware down-counter may be included in the difference determining circuit 50.) The 4-bit hardware up-counter may count either input start of frame pulses or output start of frame pulses. When the 4-bit hardware up-counter reaches its maximum value of 15d (or 16d), the output of the 5-bit up/down counter is captured, e.g., saved to a register in the display controller (not shown), and both counters are reset. The captured output of the 5-bit up/down counter corresponds with a ratio of the average rate at which data is written to the frame buffers 38, 40 and an average rate at which data is read from the frame buffers 38, 40, i.e., an average rate difference ratio. The averages are determined over a period of 15d (or 16d) frames, which may be either input or output frames.

Table 1 shows an example of how a hardware up/down counter may be used to determine a rate difference ratio. This example shows how a 5-bit hardware up/down counter that is incremented on input frame pulses and decremented on output frame start pulses may be used to estimate an average rate difference ratio. For brevity, Table 1 only shows every fourth counter value.

TABLE 1

| Counter | |
|---|---|
| Value | InFR/OutFR |
| 0 | 0.00 |
| 3 | 0.20 |
| 7 | 0.47 |
| 11 | 0.73 |
| 15 | 1.00 |
| 19 | 1.27 |
| 23 | 1.53 |
| 27 | 1.80 |
| 31 | 2.07 |

When the difference determining circuit 50 includes a hardware up/down counter, the up/down counter produces an estimate of the quotient that would be generated by a difference determining circuit 50 that includes divider logic. The accuracy of this estimate is function of the number of bits the up/down counter handles. While this description includes an example of a 5-bit up/down counter, in alternative embodiments an n-bit hardware up/down counter may be employed, where n may be any number of bits. The number of bits n may be selected, at least in part, on the desired degree of accuracy.

In the above example, the difference determining circuit 50 includes a hardware up/down counter that is incremented each time an input start of frame pulse is detected and decremented each time an output start of frame pulse is detected. In alternative embodiments, the difference determining circuit 50 may include a hardware up/down counter that is incremented each time an input start of line pulse is detected and decremented each time an output start of line pulse is detected. In one embodiment, the difference determining circuit 50 may include a hardware up/down counter that is incremented each time an input start of pixel-group pulse is detected and decremented each time an output start of pixel-group pulse is detected. In these alternative embodiments, a hardware up/down counter having a suitable number of bits may be employed.

The buffer selection unit 48 may include a write-switch point determiner 52 that determines a safe write-switch point (“SWSP”), a safe write-switch address, or both. The write-switch point determiner 52 may receive a rate difference ratio or an average rate difference ratio from the difference determining circuit 50. In one embodiment, the write-switch point determiner 52 may receive a rate difference ratio or an average rate difference ratio that corresponds with ratio (1). In one embodiment, the write-switch point determiner 52 may receive a rate difference ratio or an average rate difference ratio that corresponds with ratio (2). In one embodiment, the write-switch point determiner 52 may receive a counter output value that corresponds with a rate difference ratio or an average rate difference ratio. In determining a safe write-switch point or a safe write-switch address, the write-switch point determiner 52 may take into account the timing characteristics of the reading and writing operations as explained below. In one embodiment, the buffer selection unit 48 may include hardware logic to perform the operations described herein. In one embodiment, the buffer selection unit 48 may include an operability to execute instructions stored on a computer-readable medium to perform the operations described herein.

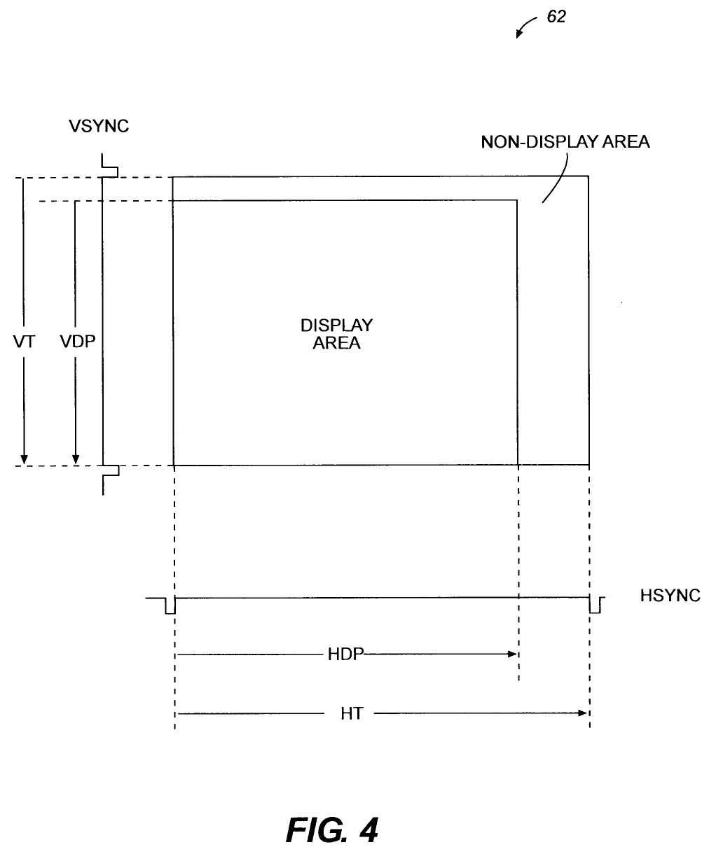

FIG. 4 illustrates representative timing characteristics that may be associated with the reading or writing of a frame. A timing specification commonly defines a time period for transferring the full frame. In FIG. 4, a vertical time (“VT”) defines the time period for transferring the full frame. All lines of a frame are transferred in the vertical time VT. In FIG. 4, a VSYNC signal demarks the boundaries of the vertical time VT. As mentioned above, a VSYNC pulse may be used as a start of frame pulse. A horizontal time (“HT”) defines the time period for transferring each of the lines. All pixels of a line are transferred in the horizontal time HT. In FIG. 4, a HSYNC signal demarks the boundaries of the horizontal time HT.

The vertical display period VDP shown in FIG. 4 defines the time period during which lines that will be displayed are transferred. The difference between VT and VDP defines the time period corresponding to the non-displayed lines of a frame. For example, a frame may have a vertical resolution of 625 lines of which 576 lines are displayed and 49 lines are not displayed. The horizontal display period HDP shown in FIG. 4 defines the time period during which pixels of a line that will be displayed are transferred. The difference between HT and HDP defines the time period corresponding to the non-displayed pixels of a line. For example, a frame may have a horizontal resolution of 864 pixels of which 720 pixels are displayed and 144 pixels are not displayed.

It is not critical that the timing characteristics of reading or writing a frame correspond with the representative timing characteristics shown in FIG. 4. Frames may be transferred using different or additional signals. In addition, frames may be transferred using signals having different temporal placement relative to the transfer of pixel data from those shown in the figure.

In one embodiment, the write-switch point determiner 52 may take into account the timing characteristics of the reading and writing operations using the following expressions:

$$\begin{matrix}inDispRatio = \frac{inVT}{inVDP} \times \frac{inHT}{inHDP} & ( 3 ) \\ outDispRatio = \frac{outVT}{outVDP} \times \frac{outHT}{outHDP} & ( 4 )\end{matrix}$$

As one example of the determination of inDispRatio, let inVT=625 lines, inVDP=313 lines, inHT=864 pixels, and inHDP=432 pixels. Substituting these values into expression (3) yields:

$$inDispRatio = \frac{625}{313} \times \frac{864}{432} = 2 \times 2 = 4$$

Similarly, as an example of the determination of outDispRatio, let outVT=625 lines, outVDP=576 lines, outHT=864 pixels, and outHDP=720 pixels. Substituting these values into expression (4) yields:

$$outDispRatio = \frac{625}{576} \times \frac{864}{720} = 1.085 \times 1.2 = 1.302$$

The write-switch point determiner 52 may determine a safe write-switch point SWSP, a safe write-switch address, or both. This determination may take into account the timing characteristics of the reading and writing operations. In addition, this determination may be based on an input rate and an output rate, or an average input rate and an average output rate, which as described above, may be expressed as a rate difference ratio or an average rate difference ratio. In one embodiment, the write-switch point may be determined using the following expression:

$$SWSP \geq 1 - \frac{outDispRatio}{inDispRatio} \times \frac{OutFR}{InFR} \qquad ( 5 )$$

The safe write-switch point SWSP may be used to identify a safe write-switch address in the current read buffer. To identify a safe write-switch address, the safe write-switch point SWSP may be multiplied by the number of addresses in a frame buffer. The safe write-switch point SWSP expresses a percentage of frame buffer addresses. The safe write-switch address is the address corresponding with that percentage.

As one example of the determination of a safe write-switch point SWSP and a safe write-switch address, let the inDispRatio and the outDispRatio take the values calculated in the above examples, and let OutFR=30 fps and InFr=38 fps. Substituting these values into expression (5) yields:

$$SWSP \geq 1 - \frac{1.302}{4} \times \frac{30}{38} = 0.74$$

Under these assumed conditions, the SWSP may be used to identify an address in the current read buffer where 74 percent of the contents of the read buffer have been read out for display. As each of the frame buffers stores 576 lines, the safe write-switch address is row 426, which represents the 74th percentile of the lines of a frame.

The determination by the write-switch point determiner 52 of a safe write-switch point SWSP, a safe write-switch address, or both may include adding a margin of error quantity to a determined SWSP or safe write-switch address. Alternatively, the determination may include multiplying or otherwise combining a determined SWSP or safe write-switch address by or with a margin of error quantity. By including a margin of error in the determination, frame tearing can be prevented in situations, for example, where the input rate varies significantly in a short time period.

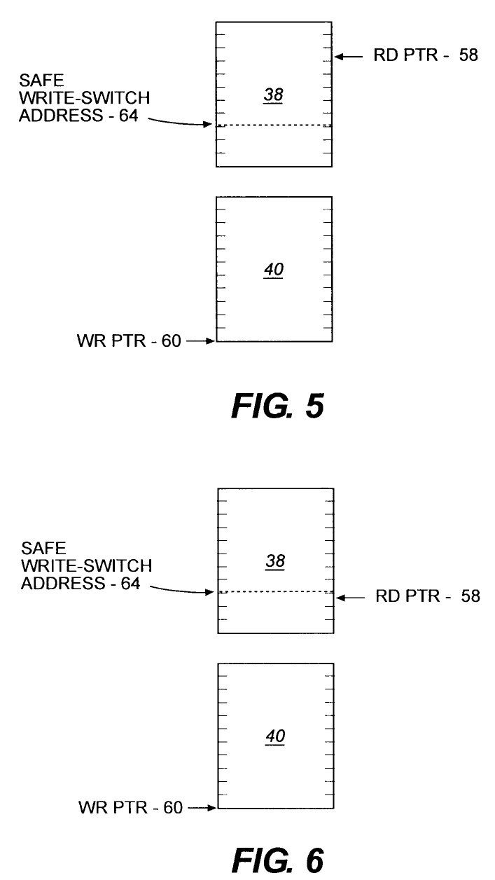

FIG. 5 is a simplified visual model of the two frame buffers 38 and 40 in which buffer 38 stores the frame currently being read for display. FIG. 5 illustrates the exemplary safe write-switch address calculated above, i.e., an address in the current read buffer 38 where 74 percent of the contents of the read buffer will have been read out for display when the read pointer 58 reaches the safe write-switch address (assuming reading from top to bottom). As shown in the example of FIG. 5, the reading of the frame for display has not progressed beyond the exemplary safe write-switch address, as indicated by the shown position of the read pointer 58. It can also be seen from FIG. 5 that the writing of a frame to frame buffer 40 has completed, as indicated by the shown position of write pointer 60. Because the read pointer 58 has not progressed beyond the exemplary safe write-switch address, it may be deemed unsafe to permit the writing of a next frame into the buffer 38. As further explained below, if the reading of a frame has not progressed beyond the safe write-switch address, the frame buffer to which data is currently being written, i.e., frame 40, may be selected for writing a next frame received from the video interface 32. Alternatively, if the reading of a frame has not progressed beyond the safe write-switch address, the next frame received from the video interface 32 may be discarded or dropped without storing in the memory 36.

FIG. 6 is a simplified visual model of the two frame buffers 38 and 40, which is identical to FIG. 5, except that it shows an example where the read pointer 58 has progressed beyond the exemplary safe write-switch address. FIG. 6 illustrates a situation where it may be deemed safe to permit the writing of a next frame into the buffer 38. As further explained below, if the reading of a frame has progressed beyond the safe write-switch address, the frame buffer from which data is currently being read for display, i.e., frame 38, may be selected for writing a next frame received from the video interface 32.

The write-switch point determiner 52 may determine a safe write-switch point SWSP or a safe write-switch address in a variety of ways. In one embodiment, the write-switch point determiner 52 may include logic to implement expression (5). The write-switch point determiner 52 may include logic to add, multiply, or otherwise incorporate a margin of error quantity in a determined safe write-switch point SWSP or safe write-switch address. The timing characteristics necessary to calculate the inDispRatio and the outDispRatio may be stored in registers (not shown) in the display controller 26. In alternative embodiments, the write-switch point determiner 52 may include a memory or registers that stores two or more predetermined safe write-switch points SWSPs or safe write-switch addresses. Each of the stored safe write-switch points SWSPs or safe write-switch addresses may correspond with one possible rate difference ratio (or average rate difference ratio) or one possible up/down counter output value. The rate difference ratios or up/down counter output values may be used as an index to the memory or registers storing the predetermined safe write-switch points SWSPs or safe write-switch addresses.

Table 2 shows an example of how a memory or registers storing predetermined average rate difference ratios and safe write-switch points SWSPs might be organized. For brevity, Table 2 only shows every fourth safe write-switch point.

TABLE 2

| InFR/OutFR | SWSP |
|---|---|
| 0.00 | 0.00% |
| 0.20 | 0.00% |
| 0.47 | 30.25% |
| 0.73 | 55.61% |
| 1.00 | 67.45% |
| 1.27 | 74.30% |
| 1.53 | 78.77% |
| 1.80 | 81.92% |
| 2.07 | 84.25% |

As one example, if a difference determining circuit 50 outputs an average rate difference ratio of 0.73, for example, then the SWSP may be determined by the write-switch point determiner 52 by looking up in memory the SWSP corresponding with the output, i.e., 55.61 percent.

Table 3 shows an example of how a memory storing counter outputs and safe write-switch points might be organized. For brevity, Table 3 only shows every fourth safe write-switch point.

TABLE 3

| Counter | |
|---|---|
| Value | SWSP |
| 0 | 0.00% |
| 3 | 0.00% |
| 7 | 30.25% |
| 11 | 55.61% |
| 15 | 67.45% |
| 19 | 74.30% |
| 23 | 78.77% |
| 27 | 81.92% |
| 31 | 84.25% |

As one example, if a difference determining circuit 50 having an up/down counter outputs a counter value of 11, for example, then the SWSP may be determined by the write-switch point determiner 52 by looking up in memory the SWSP corresponding with the output, i.e., 55.61 percent.

Referring again to FIG. 3, the buffer selection unit 48 includes a write buffer selector 54 that compares a read pointer address with the safe write-switch point SWSP or a safe write-switch address. The comparison may be made at or near a point in time when the writing of a frame to the current write buffer completes, e.g., while write VSYNC is asserted. The write buffer selector 54 selects one of the buffers 38 and 40 based, at least in part, on the result of the comparison. If the reading of the frame currently being read has progressed beyond the safe write switch address, then the write buffer selector 54 may select the current read buffer for writing a next frame. If the reading has progressed beyond the safe write switch address (as shown in FIG. 6), both reading and writing may take place simultaneously or concurrently in the same one of the two buffers 38 and 40. On the other hand, if the reading of the frame currently being read has not progressed beyond the write switch safe address (as shown in FIG. 5), then the write buffer selector 54 may select the buffer that was most recently used for writing a frame for writing a next frame. If the reading has not progressed beyond the safe write switch address (as shown in FIG. 5), the frame most recently written may be overwritten with a next incoming frame as a result of the selection of the most recently used write buffer. Alternatively, if the reading has not progressed beyond the safe write switch address (as shown in FIG. 5), a next incoming frame may be discarded or dropped without being stored in the memory 36. In the example shown in FIG. 5, the next sequential frame may be written to frame buffer 40 or simply dropped.

In one embodiment, the write buffer selector 54 may include hardware logic to perform the operations described herein. In one embodiment, the write buffer selector 54 may include an operability to execute instructions stored on a computer-readable medium to perform the operations described herein.

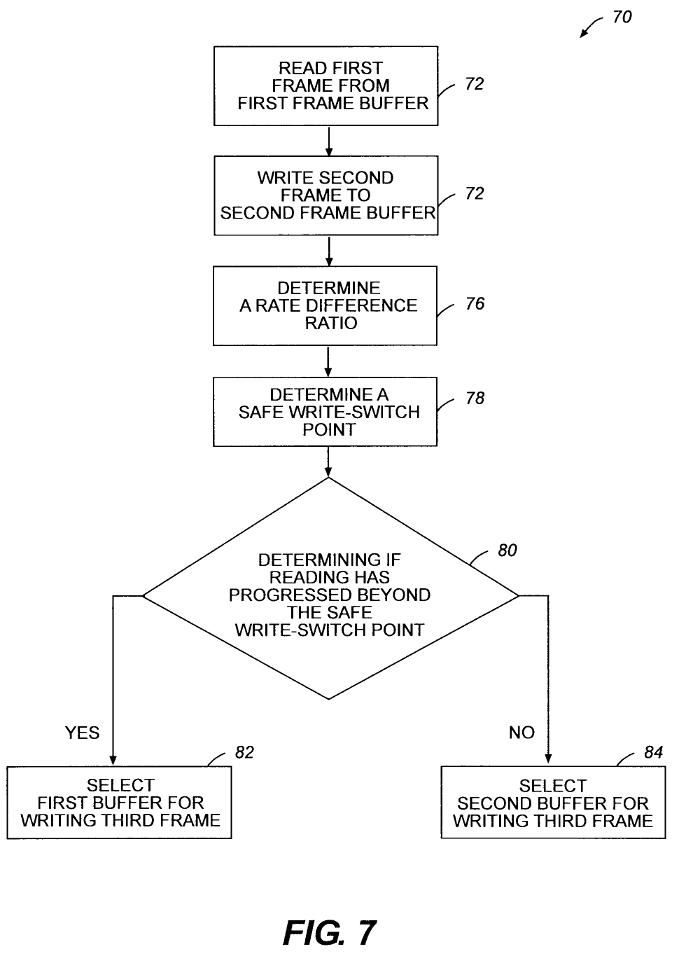

FIG. 7 illustrates one embodiment of an operational flow 70 for buffering a sequence of frames of image data. Image data of a first frame is read from a first one of two frame buffers in an operation 72. In operation 72, the first frame may be read for transmission to the display device 28. The operation 72 may be performed by a display pipe 46, the display interface 34, a display pipe sequencer (not shown), or a combination of one or more of the foregoing units. Image data of a second frame is written to a second one of the two frame buffers in an operation 74. In operation 74, the second frame may be a frame received from the video source 24. The operation 74 may be performed by the host interface 30 or the video interface 32, or these two units in combination. The operations 72 and 74 may overlap in time. The first frame may precede the second frame in a sequence of frames.

In operation 76, a rate difference ratio is determined. The determination made in operation 76 is based on a ratio of an input rate and an output rate, where the input rate is a rate at which image data is written to the two frame buffers, and the output rate is a rate at which image data is read from the two frame buffers. In some alternative methods, the rate difference ratio is an average rate difference ratio based on a ratio of an average input rate and an average output rate. The input rate, the output rate, or both the input and output rates may be non-constant rates or may vary with time. The operation 76 may be performed by the buffer selection circuit 48.

In operation 78, a safe write-switch point in the first frame buffer is determined. The safe write-switch point may be determined based at least in part on the rate difference ratio. In addition, the safe write-switch point may be determined in part by a margin of error quantity. The operation 78 may be performed by the buffer selection circuit 48.

In operation 80, it is determined whether the reading of image data from the first frame buffer has progressed beyond the safe write-switch point. In operations 82 and 84, one of the two buffers may be selected for writing a third frame. The second frame may precede the third frame in the sequence of frames. In operation 82, the first buffer is selected for writing the third frame because it is determined that the reading of the first frame has progressed beyond the safe write-switch point. In operation 84, the first buffer is not selected to receive image data of the third frame because the reading of the first frame has not progressed beyond the safe write-switch point. The operation 84 may include selecting the second buffer for writing the third frame, as shown in FIG. 7. Alternatively, the operation 84 may include selecting the second buffer, but not writing the third frame to either of the two frame buffers (not shown). In this alternative, the third frame may be discarded or dropped. The operation 80 may be performed by the buffer selection circuit 48.

In one embodiment, some or all of the operations and methods described in this description may be performed by executing instructions that are stored in or on a computer-readable medium. The term “computer-readable medium” may include, but is not limited to, non-volatile memories, such as EPROMs, EEPROMs, ROMs, floppy disks, hard disks, flash memory, and optical media such as CD-ROMs and DVDs.

In this description, references may be made to “one embodiment” or “an embodiment.” These references mean that a particular feature, structure, or characteristic described in connection with the embodiment is included in at least one embodiment of the claimed inventions. Thus, the phrases “in one embodiment” or “an embodiment” in various places are not necessarily all referring to the same embodiment. Furthermore, particular features, structures, or characteristics may be combined in one or more embodiments.

Although embodiments have been described in some detail for purposes of clarity of understanding, it will be apparent that certain changes and modifications may be practiced within the scope of the appended claims. Accordingly, the described embodiments are to be considered as illustrative and not restrictive, and the claimed inventions are not to be limited to the details given herein, but may be modified within the scope and equivalents of the appended claims. Further, the terms and expressions which have been employed in the foregoing specification are used as terms of description and not of limitation, and there is no intention in the use of such terms and expressions to exclude equivalents of the features shown and described or portions thereof, it being recognized that the scope of the inventions are defined and limited only by the claims which follow.

I claim:

1. An apparatus for double-buffering a sequence of frames of pixel data, comprising:
two frame buffers, and a read unit to read a first frame of pixel data from a first one of the two frame buffers;
a write-switch point determiner to determine a safe write-switch point in the first one of the two frame buffers, the safe write-switch point being determined, at least in part, by an average rate at which data is written to the frame buffers and an average rate at which data is read from the frame buffers; and
a write-buffer selector to determine if the reading of the first frame has progressed beyond the safe write-switch point, and to select one of the two frame buffers to write a second frame of pixel data based on the determination.

2. The apparatus of claim 1, wherein at least one of a rate at which data is written to the frame buffers and a rate at which data is read from the frame buffers varies with time.

3. The apparatus of claim 1, wherein at least one of the average rate at which data is written to the frame buffers and the average rate at which data is read from the frame buffers varies with time.

4. The apparatus of claim 1, wherein the write-buffer selector selects the first one of the two frame buffers to write the second frame based on a determination that the reading of the first frame has progressed beyond the safe write-switch point.

5. The apparatus of claim 1, wherein the write-buffer selector selects a second one of the two frame buffers to write the second frame based on a determination that the reading of the first frame has not progressed beyond the safe write-switch point.

6. The apparatus of claim 1, wherein the write-buffer selector is operable to:
select a second one of the two frame buffers to write a second frame based on a determination that the reading of the first frame has not progressed beyond the safe write-switch point, and
block the writing of the second frame to either of the two frame buffers.

7. The apparatus of claim 1, wherein the first and second frame buffers are each sized to store a single frame of pixel data.

8. The apparatus of claim 1, wherein the write-switch point is determined in part by a margin of error quantity.

9. The apparatus of claim 1, wherein the safe write-switch point is determined, at least in part, by an average rate at which frames are read from the two frame buffers and an average rate at which frames are written to the two frame buffers.

10. The apparatus of claim 1, wherein the pixel data of each frame is arranged as a plurality of lines of pixels, and the safe write-switch point is determined, at least in part, by an average rate at which lines of pixels are read from the two frame buffers and an average a rate at which lines of pixels are written to the two frame buffers.

11. The apparatus of claim 1, wherein the pixel data of each frame is arranged as a plurality of lines of pixels, and the safe write-switch point is determined, at least in part, by an average rate at which groups of one of more pixels are read from the two frame buffers and an average a rate at which groups of one of more pixels are written to the two frame buffers.

12. The apparatus of claim 1, wherein the write-switch point determiner includes at least one memory to store at least two predetermined safe write-switch points.

13. A method for buffering a sequence of frames of pixel data, comprising:
reading pixel data of a first frame from a first one of two frame buffers;
writing pixel data of a second frame to a second one of the two frame buffers;
determining a rate difference ratio based on a ratio of an input rate and an output rate, the input rate being a rate at which pixel data is written to the two frame buffers and the output rate being a rate at which pixel data is read from the two frame buffers;
determining a safe write-switch point in the first frame buffer based at least in part on the rate difference ratio;
determining whether the reading of pixel data from the first frame buffer has progressed beyond the safe write-switch point; and
selecting one of the two frame buffers to write the pixel data of a third frame to based on the determination of whether the reading of pixel data from the first frame buffer has progressed beyond the safe write-switch point,
wherein the first buffer is not selected to receive pixel data of the third frame if the reading of the first frame has not progressed beyond the safe write-switch point.

14. The method of claim 13, wherein the rate difference ratio is an average rate difference ratio based on a ratio of an average input rate and an average output rate.

15. The method of claim 13, wherein at least one of the input rate and the output rate varies with time.

16. The method of claim 13, wherein the determining of a safe write-switch point is determined in part by a margin of error quantity.

17. The method of claim 13, wherein the selecting one of the two buffers to write the pixel data of a third frame to includes selecting the first frame buffer to write the third frame to if it is determined that the reading of the first frame has progressed beyond the safe write-switch point.

18. The method of claim 13, wherein the selecting one of the two buffers to write the pixel data of a third frame to includes selecting the second frame buffer to write the third frame to if it is determined that the reading of the first frame has not progressed beyond the safe write-switch point.

19. An apparatus for double-buffering a sequence of frames of pixel data for display, comprising:
two frame buffers, and a read unit to read a first frame of pixel data from a first one of the two frame buffers for display;
a write-switch point determiner to determine a safe write-switch point in the first one of the two frame buffers, the safe write-switch point being determined, at least in part, by an average rate at which data is written to the frame buffers and an average rate at which data is read from the frame buffers;
a write-buffer selector to determine if the reading of the first frame has progressed beyond the safe write-switch point, and to select one of the two frame buffers to write a second frame of pixel data based on the determination; and
wherein:
the write-buffer selector selects a second one of the two frame buffers to write the second frame based on a determination that the reading of the first frame has not progressed beyond the safe write-switch point, and
at least one of a rate at which data is written to the frame buffers and a rate at which data is read from the frame buffers is a non-constant rate.

20. The apparatus of claim 19, wherein the apparatus includes at least one memory to store at least two predetermined safe write-switch points.

21. The apparatus of claim 19, wherein the safe write-switch point is determined, at least in part, by an average rate at which frames are read from the two frame buffers and an average rate at which frames are written to the two frame buffers.

22. The apparatus of claim 21, wherein the apparatus includes at least one up/down counter to determine an average rate difference ratio.

23. The apparatus of claim 19, wherein the first and second frame buffers are each sized to store a single frame of pixel data.

24. The apparatus of claim 19, wherein the write-buffer selector selects the first one of the two frame buffers to write the second frame based on a determination that the reading of the first frame has progressed beyond the safe write-switch point.

25. The apparatus of claim 19, wherein the pixel data includes data pixels that have been compressed or encoded.

26. The apparatus of claim 19, wherein the pixel data includes pixel data components obtained using an under-sampling technique, the pixel data including all of pixel data components that are necessary to reconstruct all of the data pixels of a frame.
